(19) United States
(12) Patent Application Publication
(10) Pub. No.: US 2026/0279319 A1
(43) Pub. Date: Sep. 17, 2026

(54) High-Fidelity Stereo Vocoder

(71) Applicant: Adobe Inc., San Jose, CA (US)

(72) Inventors: Ge ZHU, San Francisco, CA (US); Juan-Pablo CACERES CHOMALI, San Francisco, CA (US); Nicholas J. BRYAN, Belmont, CA (US)

(73) Assignee: Adobe Inc., San Jose, CA (US)

(21) Appl. No.: 19/221,151

(22) Filed: May 28, 2025

Related U.S. Application Data
(60) Provisional application No. 63/772,383, filed on Mar. 14, 2025.

(51) Int. Cl. G10H 1/02

(52) U.S. Cl. CPC G10H 1/02; G10H 2250/251; G10H 2250/311

(57) ABSTRACT

Embodiments are disclosed for music generation. The method may include obtaining a music representation. A high-fidelity vocoder can then generate low-resolution audio data based on the music representation. A bandwidth extension module generates high-resolution monophonic audio data based on the low-resolution audio data and the music representation. A mono-to-stereo module generates high-resolution stereophonic audio data based on the high-resolution monophonic audio data.

### CROSS-REFERENCE TO RELATED APPLICATIONS

This application claims the benefit of U.S. Provisional Application No. 63/772,383, filed Mar. 14, 2025, which is hereby incorporated by reference.

### BACKGROUND

Recently, there has been an increase of interest in diffusion models. These models typically allow for realistic images to be generated based on text prompts. This has enabled creators of varying skill levels to convert high-level intent into images which may then be incorporated into other creative work. For example, large-scale diffusion generative models have transformed the creative landscape across a range of modalities and have begun to show promising results for text-to-music generation.

### SUMMARY

Introduced here are techniques/technologies that enable music generation using a cascade of generative adversarial network (GAN) based models. Embodiments include a music generation system which includes a high-fidelity vocoder, a bandwidth extension module, and a mono-to-stereo module. These three modules share a unified GAN architecture and are executed in sequence to convert a representation of music, such as a spectrogram or other pixel-based representation, into audio data.

The GAN-based models progressively increase the fidelity of the generated music. For example, a representation of music (e.g., a spectrogram or other pixel-based representation) is provided by a user, system, service, or other entity to the music generation system. The high-fidelity vocoder generates a low-resolution audio signal based on the music representation. The low-resolution audio signal can then be provided to the GAN-based bandwidth extension module which upsamples the low-resolution audio to generate high-resolution monophonic audio. The high-resolution monophonic audio can then be provided to the GAN-based mono-to-stereo module to generate stereophonic high-resolution audio. As such, embodiments can efficiently convert a pixel-based representation of music into high quality audio. Additionally, the intermediate outputs of the modules are each interpretable and listenable, enabling the user to monitor the output as it is generated and make changes as needed at the specific point in the pipeline where changes may be needed.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of music generation in accordance with one or more embodiments;

FIG. 2 illustrates a diagram of a mono-to-stereo module in accordance with one or more embodiments;

FIG. 3 illustrates a diagram of a GAN-based high-fidelity vocoder in accordance with one or more embodiments;

FIG. 4 illustrates a diagram of a GAN-based bandwidth extension module in accordance with one or more embodiments;

FIG. 5 illustrates a diagram of a GAN-based mono-to-stereo module in accordance with one or more embodiments;

FIG. 6 illustrates a diagram of an audio restoration system 600, in accordance with one or more embodiments;

FIG. 7 illustrates a schematic diagram of music generation system in accordance with one or more embodiments;

FIG. 8 illustrates a flowchart of a series of acts in a method of music generation in accordance with one or more embodiments; and

FIG. 9 illustrates a block diagram of an exemplary computing device in accordance with one or more embodiments.

### DETAILED DESCRIPTION

One or more embodiments of the present disclosure include a music generation system which includes a high-fidelity stereo vocoder which can convert low-resolution images of audio (e.g., Mel-spectrograms) to high-fidelity stereo-channel audio signals. Recent music generation models have demonstrated promising text-to-music (TTM) generation capabilities and offer an exciting new way to create music. These image generation techniques typically include using image-domain diffusion techniques to generate two-dimensional image representations of music, followed by an image-to-audio converter or vocoder. Using such systems, much of the musicality of generated music comes from the text-to-image generation module and much of the music fidelity comes from the vocoder module. Existing vocoder techniques include generative adversarial networks (GANs) vocoders such as MelGAN, HiFi-GAN, and BigVGAN and diffusion-based vocoders such as DiffWave.

While both GAN and diffusion-based vocoders have been successful for speech generation, such methods have limited application for music generation. That is, typical state-of-the-art speech vocoders have a sampling rate of 22 kHz-24 kHz or less and are single-channel (e.g., monophonic). Such performance is generally acceptable for speech generation, which typically only includes frequencies up to 11-12 kHz. However, these techniques are insufficient for music generation, which requires at least a 44.1 kHz sampling rate and two-channel (e.g., stereophonic) signals to match compact disc or streaming quality. Furthermore, diffusion-based methods are significantly slower than GAN-based methods. Attempts have been made to improve upon GAN-based vocoders, such as through bandwidth expansion and mono-to-stereo conversions. However, these attempts suffer from several drawbacks, such as slow inference speed, algorithms that are not differentiable/learnable, and/or more complicated or ad hoc designs.

To address the shortcomings of existing techniques, embodiments provide an efficient, high-fidelity stereo vocoder which can convert image representations of music to 44.1 kHz stereo audio using a unified design. For example, in some embodiments, the high-fidelity vocoder can receive an image of music (e.g., a 22.05 kHz Mel-spectrogram) and progressively upsample it to high-fidelity audio. This process can include first converting an image-based representation of music to low-quality (e.g., low-resolution) audio, upsampling the low-quality audio to high-quality (e.g., high-resolution) monophonic audio via a bandwidth expander (BWE), and then converting the monophonic high-resolution audio to stereophonic high-resolution audio (M2S).

Unlike the prior attempts to improve GAN-based vocoders discussed above, embodiments include a unified GAN-based generator and discriminator architecture for all three modules (e.g., image-to-audio, bandwidth expansion, and mono-to-stereo) used without modification except loss inputs and output targets. Additionally, embodiments use a novel cycle-consistent mono-to-stereo module that preserves the monophonic content of the output via a middle-side encoding. Also, in some embodiments, a near cycle-consistent bandwidth extension module is used to the preserve the low-frequency content of upsampled content. This produces state-of-the-art image-to-audio conversion and mono-to-stereo results with extraordinarily efficient generation and interpretable intermediate outputs.

Embodiments achieve state-of-the-art image to audio conversion using a cascade of generative adversarial network (GAN)-based models (e.g., a GAN-triplet) that progressively increases the fidelity of generated music. A representation of music is provided by a user, system, service, or other entity to the music generation system. This representation may be a Mel-spectrogram, or other pixel-based representation of music, and may be generated by a machine learning model (e.g., a diffusion model or other model trained to generate pixel-based representations of music). The representation of music is provided to the high-fidelity (e.g., HiFi) vocoder which generates a low-resolution audio signal. The low-resolution audio signal can then be provided to the GAN-based bandwidth extension module which upsamples the low-resolution audio to generate high-resolution monophonic audio. The high-resolution monophonic audio can then be provided to the GAN-based mono-to-stereo module to generate stereophonic high-resolution audio. As such, embodiments can efficiently convert a pixel-based representation of music into high quality audio. Additionally, the intermediate outputs of the modules are each interpretable and listenable, enabling the user to monitor the output as it is generated and make changes as needed at the specific point in the pipeline where changes may be needed.

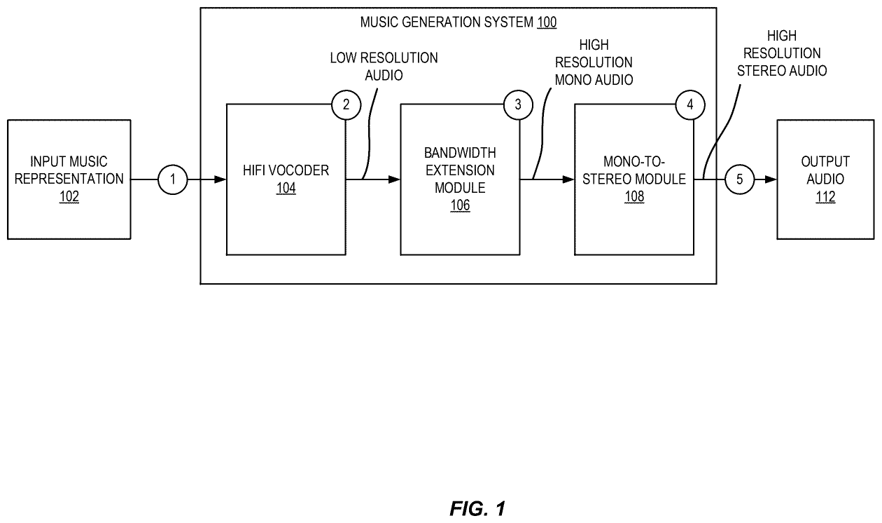

FIG. 1 illustrates a diagram of a process of music generation in accordance with one or more embodiments. The example of FIG. 1 includes a music generation system 100. Music generation system 100 can be implemented in various computing environments (e.g., a cloud-based application, a standalone application executing on an end user device, etc.). As such, the elements shown in the example of FIG. 1 may be executing on the same computing device and/or execution may be spread across components executing on diverse local and/or remote computing devices.

As shown in FIG. 1, the music generation system 100 can include GAN-based modules in cascade. In this example, the music generation system 100 includes three GAN-based modules (e.g., a triplet-cascade) which are executed in sequence to convert an input music representation 102 to high-resolution output audio 110. At numeral 1, input music representation 102 is received by music generation system 100. As discussed, the input music representation 102 may be a pixel-based representation, such as a Mel-spectrogram or other image. In some embodiments, the music representation 102 can be generated by a diffusion model or obtained from another source. The diffusion model can include any of various diffusion models trained to generate a visual, audio, or latent representation of music based on one or more inputs, such as a text input. In some embodiments, the diffusion model may be provided as a component of music generation system 100 or another system in communication with music generation system 100. Examples of such models may include a text-to-spectrogram model or a text-to-latent diffusion model that is paired with a latent decoder. Such models may be implemented using neural networks, such as a U-net architecture, a transformer architecture, etc.

A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

At numeral 2, the input music representation 102 is received by HiFi vocoder 104. In various embodiments, the music representation (also referred to as a representation of music) can be audio, pixel data, latent vectors, etc. HiFi vocoder 104 can be implemented using a GAN architecture which may be trained to generate low resolution audio based on an input image or other pixel-based representation of music. The low-resolution audio is provided to bandwidth extension module 106. Bandwidth extension module 106 can be implemented using the same GAN architecture as the HiFi vocoder 104 but trained to generate high-resolution audio based on input low-resolution audio. At numeral 3, bandwidth extension module 106 upsamples the low-resolution audio to generate the high-resolution audio. The generated high-resolution audio is single channel (e.g., monophonic).

The high-resolution audio, or a representation thereof, can be provided to mono-to-stereo module 108. Mono-to-stereo module 108 can also be implemented using the same GAN architecture as the other modules. For the mono-to-stereo module 108, the network is trained to generate stereophonic audio based on a representation of monophonic audio data. As discussed, in some embodiments, the mono-to-stereo module 108 can receive the representation of the high-resolution monophonic audio data and its corresponding generated audio data (e.g., waveform data). At numeral 4, the mono-to-stereo module 108 can predict the side channel audio data based on a representation of the high-resolution monophonic audio data. The resulting side channel audio data and high-resolution monophonic audio data can then be used to decode the high-resolution stereophonic audio data (e.g., left and right channels). The high-resolution stereo audio data is then output as output audio 112, at numeral 5.

Each module (e.g., HiFi vocoder 104, bandwidth extension module 106, and mono-to-stereo module 108) can be trained independently using the same generator and discriminator architecture, albeit with different inputs and target outputs for training loss as discussed further below.

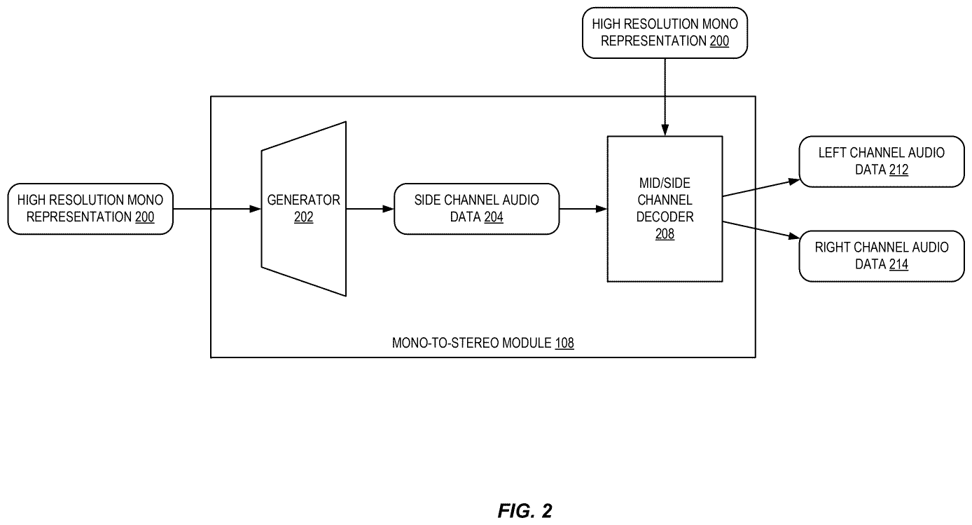

FIG. 2 illustrates a diagram of a mono-to-stereo module in accordance with one or more embodiments. As shown in FIG. 2, mono-to-stereo module 108 can receive high-resolution monophonic audio representation 200 from bandwidth extension module 106. In some embodiments, the high-resolution monophonic audio representation 200 is a Mel-spectrogram, or other pixel-based representation of the upsampled audio generated by bandwidth extension module 106.

The mono-to-stereo module 108 uses mid/side encoding to generate the high-resolution stereo audio data. As shown in FIG. 2, the mono-to-stereo module 108 includes a generator 202. In some embodiments, the generator 202 may be the same generator architecture in each module. For example, in some embodiments, the generator architecture may be BigVGAN transpose 1D convolution+AMP block generator architecture, which receives as input a Mel-spectrogram and outputs audio data.

In the example of FIG. 2, the generator 202 of the mono-to-stereo module 108 receives a representation of the high-resolution monophonic audio representation 200 and outputs side channel audio data. The monophonic audio is treated as a mid-channel which comprises a sum of the left and right channels. The predicted side channel comprises a difference of the left and right channels. The mid/side channel decoder 208 can use the side channel audio data 204 and the high-resolution monophonic audio representation 200 (e.g., the audio data generated by the bandwidth extension module 106) to decode the left channel audio data 212 and the right channel audio data 214.

For example, the high-resolution monophonic audio representation 200, M, and the side channel audio data, S, can be represented as

$$M = \frac{( L + R )}{2} and S = \frac{( L - R )}{2} ,$$

where L and R are the left and right stereo channel respectively. As such, the mid/side channel decoder 208 can receive the side channel audio data 204 generated by generator 202 and the high-resolution monophonic audio representation 200 generated by the bandwidth extension module, and reconstruct the left and right output channels via L=M+S and R=M−S.

As a result of leveraging mid-side encodings, the music generation system is cycle-consistent or downmix-compatible in that the mono channel can be upsampled to stereo, and then downsampled back to mono, and the original mono channel will be recovered perfectly. This is not the case with alternative methods which typical degrade results after repeated applications. Furthermore, an additional control mechanism can be added to adjust the spatialization width by controlling the energy ratio between the side and mid-channels. This can be done by normalizing the mid-channel and side-channel energies to 0 dB and then setting a scalar coefficient α to control the side/mid energy ratio via Ŝ←αS, where

$$α = 1 {0}^{\frac{γ}{20}} ,$$

where γ is a scalar factor in decibels. When γ>0, there will be more side energy and when γ<0, there will be less side energy.

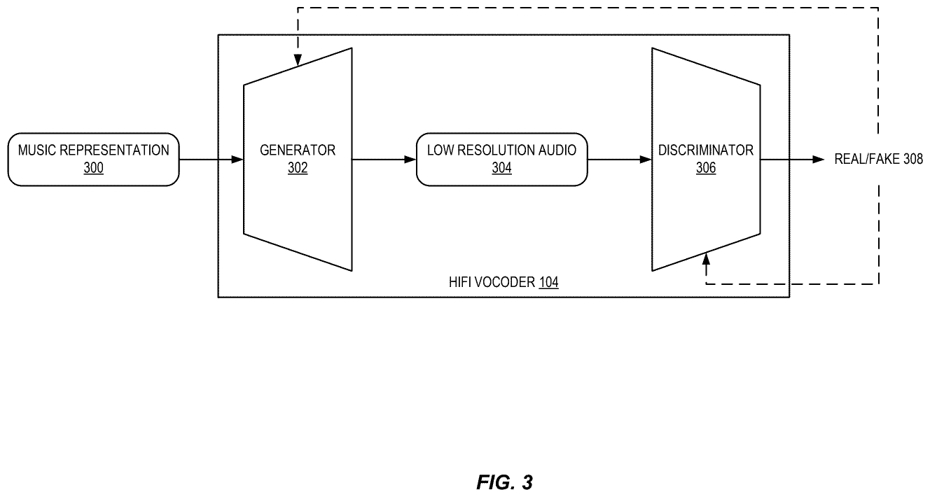

FIG. 3 illustrates a diagram of a GAN-based high-fidelity vocoder in accordance with one or more embodiments. As discussed, each module of the music generation system implements a shared generator and discriminator architecture. In the example of FIG. 3, the HiFi vocoder 104 includes generator 302 which receives a music representation 300 and outputs low-resolution audio data 304. For example, in some embodiments, the generator architecture may be BigVGAN transpose 1D convolution+AMP block generator architecture, which receives as input a Mel-spectrogram and outputs audio data.

During training, the HiFi vocoder 104 also includes a discriminator 306, which receives the generated low-resolution audio 304 and determines whether the generated audio is real or fake 308. In some embodiments, the discriminator 306 may be a DAC discriminator. Based on the evaluation by the discriminator, the generator 302 can and discriminator 306 can be trained. In some embodiments, the training objective can include a reconstruction loss and adversarial loss, such as those used by the DAC discriminator. In some embodiments, other learning objectives, such as the codebook learning objective can be removed, since the focus is high-fidelity audio synthesis instead of neural compression. The final training objective for our generator ( [symbol] ) and discriminator ( [symbol] ) are:

$${ℒ}_{G} = {\sum }_{k = 1}^{K} [ {ℒ}_{adv} ( G ; {D}_{k} ) + {λ}_{fm} {ℒ}_{fm} ( G ; {D}_{k} ) ] + {λ}_{rc} {ℒ}_{rc} ( G )$$

$${ℒ}_{D} = {\sum }_{k = 1}^{K} [ {ℒ}_{adv} ( {D}_{k} ; G ) ]$$

where Dₖ denotes the k-th subdiscriminator from MPD or MMSD, [symbol] _{adv}, [symbol] _{rc}, [symbol] _{fm} represent least-square adversarial loss, reconstruction loss, and L1-based feature matching loss, respectively. Specifically,

$${ℒ}_{rc} = {\sum }_{i} {‖ log {S}_{i} - log {\hat{S}}_{i} ‖}_{1}$$

where Sᵢ indicates the i-th Mel-spectrogram from a list of Mel-spectrograms with different fixed resolutions. [symbol] _{fm} aims to minimize the distances between real and generated intermediate features from the discriminator layers.

As discussed, the HiFi vocoder receives as input Mel-spectrograms computed from low sampling-rate audio and outputs low-resolution audio waveforms, but otherwise follows the unified generator, discriminator, and training process described above. This training process produces a more stable generator that is less susceptible to mode collapse when scaled up to larger models when compared to other training processes, such as that associated with BigVGAN. In contrast, embodiments can double the input sequence length (from 8192 to 16384) and, using this training process, can use a larger convolution channel width of 2048 to increase model capacity without observing mode collapse.

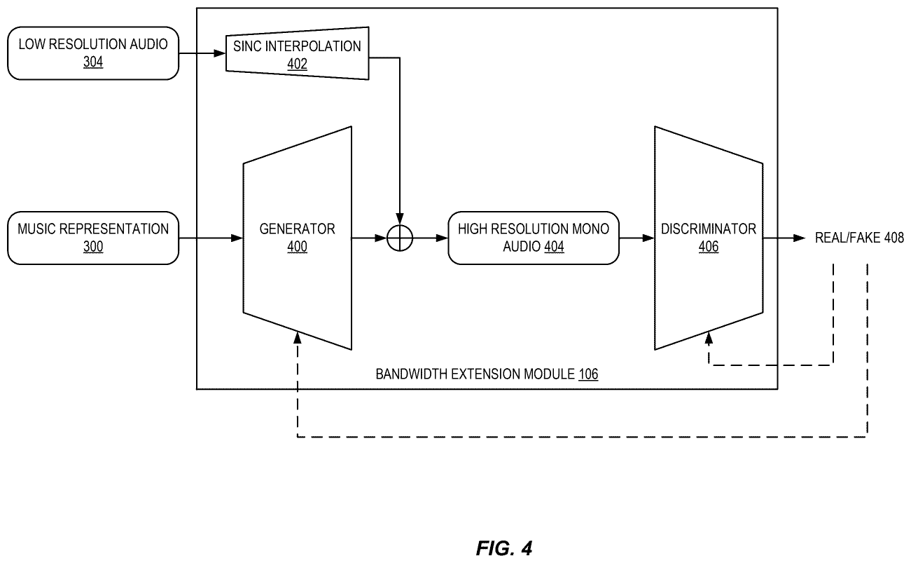

FIG. 4 illustrates a diagram of a GAN-based bandwidth extension manager in accordance with one or more embodiments. The bandwidth extension module 106 can receive the low-resolution audio 304 generated by the HiFi decoder and output high-resolution. As discussed, the generator 400 and discriminator 406 and training process may be unified across all three modules. In some embodiments, the generator 400 includes several customizations. For example, the low-resolution audio 304 can be used to compute an intermediate Mel-spectrogram representation with half the hop size used for the vocoder (e.g., to double the sequence length and match the intended full-band, e.g., high resolution, waveform output).

Additionally, in some embodiments, a residual or skip connection is added between the input low-resolution audio signal and high-resolution audio output. For example, as shown in FIG. 4, the low-resolution audio data can be input over the skip connection with a sinc interpolation 402 block in-between that performs upsampling. In some embodiments, the upsampling may be 2× upsampling. Alternatively, other upsampling rates may be performed. The residual connection enables the bandwidth extension module 106 to more easily generate low-bandwidth content and allows the bandwidth extension module 106 generator to focus model capacity on generating high-frequency content. The interpolated low-resolution audio signal is combined with the intermediate monophonic audio data and the combined outputs then serve as the predicted full-band waveform and are trained alongside the ground truth full-band waveform.

During training, the bandwidth extension module 106 also includes a discriminator 406, which receives the generated high-resolution audio 404 and determines whether the generated audio is real or fake 408. As discussed, the discriminator 406 can be implemented using the same architecture as that of the other modules. The discriminator 406 may be a DAC discriminator. Based on the evaluation by the discriminator, the generator 400 can and discriminator 406 can be trained.

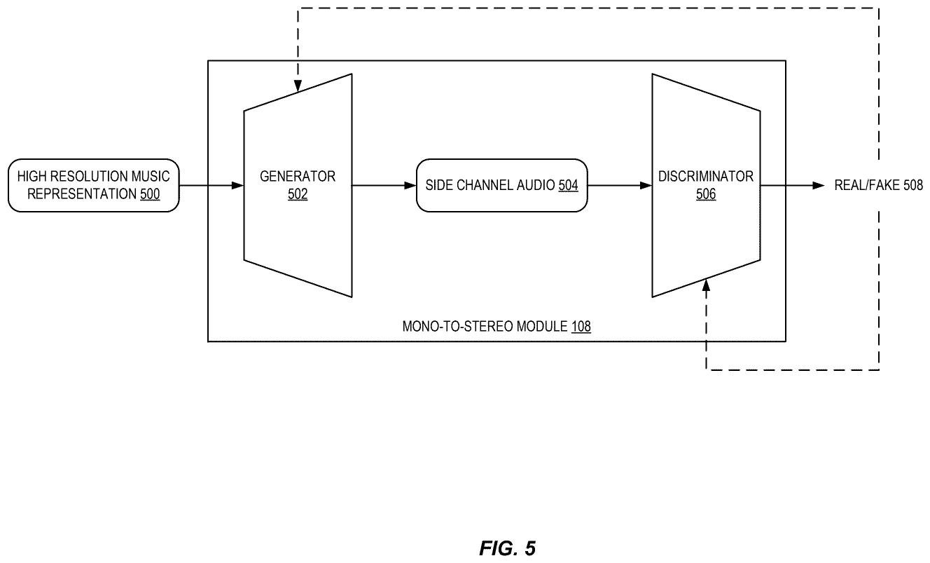

FIG. 5 illustrates a diagram of a GAN-based mono-to-stereo manager in accordance with one or more embodiments. As discussed, the mono-to-stereo (M2S) module 108, can also include the unified generator architecture, discriminator architecture, and training process as in the other modules. To create a stereo effect from a mono audio signal, however, embodiments leverage a mid-side encoding to convert stereo left and right signals into a summation channel (e.g., mid channel) and a difference channel (e.g., side channel). For example, the high-resolution monophonic music generated by the bandwidth extension module can be treated as the summation channel. The M2S module 108 can be trained to receive the Mel-spectrogram of the mid-channel M and output the side channel waveform S, where

$$M = \frac{( L + R )}{2} and S = \frac{( L - R )}{2} ,$$

where L and R are the left and right stereo channel respectively. Subsequently, as discussed, a mid/side decoder can reconstruct left and right output channels via L=M+S and R=M−S. The discriminator is trained to evaluate the side channel audio 504 as being real or fake 508 and then the discriminator 506 and generator 502 can be trained based on the evaluation.

As a result of leveraging mid-side encodings, embodiments are cycle-consistent or downmix-compatible in that it can take mono channel audio data, upsample it to stereo audio data, downsample back to mono audio data, and recover the original mono channel perfectly. This is not the case with alternative methods which typically degrade results after repeated applications. Furthermore, an additional control mechanism can be added to adjust the spatialization width by controlling the energy ratio between the side and mid-channels. This can be done by normalizing the mid-channel and side-channel energies to 0 dB and then setting a scalar coefficient α to control the side/mid energy ratio via Ŝ←αS, where

$$α = 1 {0}^{\frac{γ}{20}} ,$$

where γ is a scalar factor in decibels. When γ>0, there will be more side energy and when γ<0, there will be less side energy.

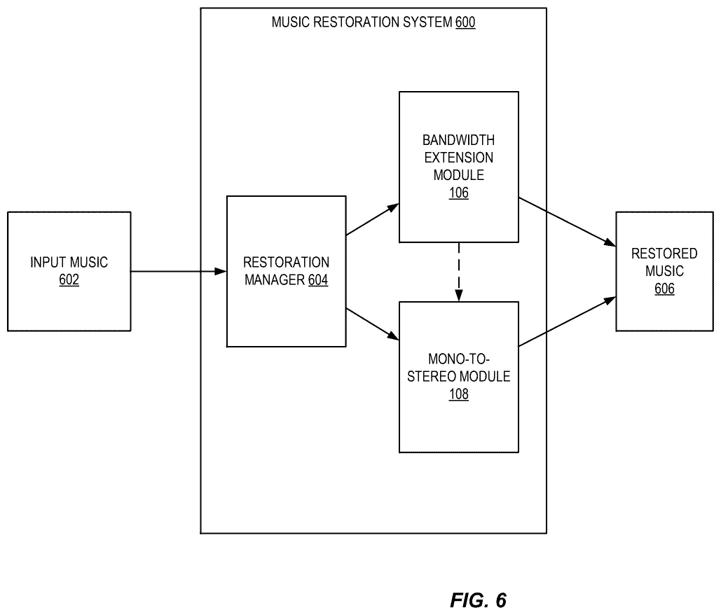

FIG. 6 illustrates a diagram of an audio restoration system 600, in accordance with one or more embodiments. As discussed, the bandwidth extension module 106 and mono-to-stereo module 108 can be used together for music generation. However, in various embodiments, the bandwidth extension module and/or mono-to-stereo manager 108 can be used independently, or in combination, for music restoration.

In the example of FIG. 6, music restoration system 600 can include bandwidth extension module 106 and mono-to-stereo module 108. A user can provide input music 602 to music restoration system 600. Input music 102 can include low quality audio from various sources (e.g., old recordings, analog to digital conversions, low quality encodings, etc.). In some embodiments, the music restoration system 600 can include a restoration manager 604 which enables the user to select the type of audio restoration to be performed. In some embodiments, the restoration manager 604 can analyze the input music and determine the appropriate form of restoration to be applied.

For example, the user may choose to have bandwidth expansion performed on the input music 602. In such instances, the input music 602 may be provided to the bandwidth extension module 106 and, as discussed, high resolution monophonic audio can be output as restored music 606. Alternatively, the user may choose to have the input music 602 converted into stereo audio using mono-to-stereo module 108, as discussed herein. This likewise may produce restored music 606. In some embodiments, the user may choose to have both bandwidth extension and stereo conversion performed. In the above examples, if a Mel-spectrogram or other music representation of the input music is needed, it can be computed and used for bandwidth extension and/or stereo conversion.

In some embodiments, a method of music restoration can include receiving a request to restore input music and executing one or more of a plurality of generative adversarial network (GAN) based models to progressively increase fidelity of the input music. Restored music generated by the one or more of the plurality of GAN based models can then be output. In some embodiments, the one or more of the plurality of GAN based models includes at least one of a bandwidth extension module which generates high-resolution monophonic audio data based on the input music and a mono-to-stereo module which generates high-resolution stereophonic audio data based at least on the input music.

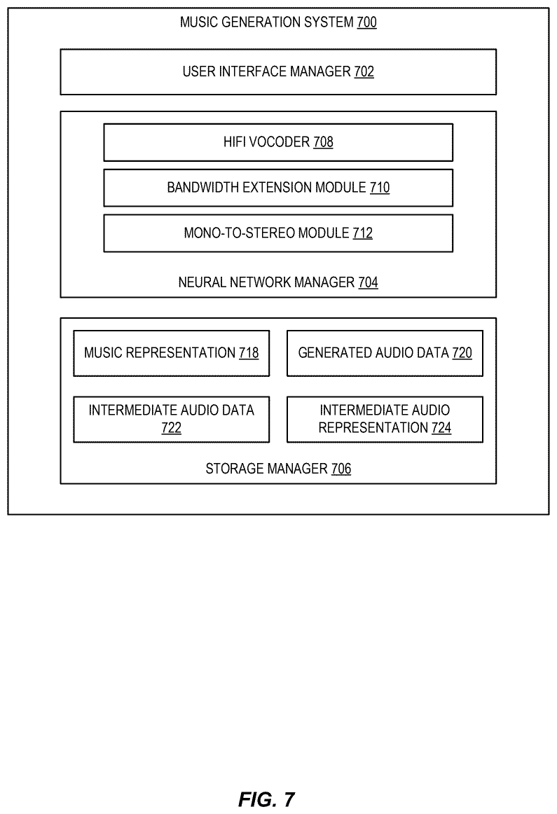

FIG. 7 illustrates a schematic diagram of a music generation system (e.g., “music generation system” described above) in accordance with one or more embodiments. As shown, the music generation system 700 may include, but is not limited to, user interface manager 702, neural network manager 704, and storage manager 706. The neural network manager 704 includes HiFi vocoder 708, bandwidth extension module 710, and mono-to-stereo module 712. The storage manager 706 includes music representation 718, generated audio data 720, intermediate audio data 722, and intermediate audio representation 724.

As illustrated in FIG. 7, the music generation system 700 includes a user interface manager 702. For example, the user interface manager 702 allows users to provide a music representation 718, prompt text, etc. to the music generation system 700. In some embodiments, the user interface manager 702 provides a user interface through which the user can select the music representation 718 from a local or remote storage location accessible to the music generation system 700. In some embodiments, the music generation system 700 can generate the music representation using, e.g., a diffusion model. In such instances, the user interface manager 702 can provide a user interface through which the user can enter a prompt which describes the music to be generated.

Additionally, the user interface manager 702 allows users to request the music generation system 700 to generate audio data 720 (e.g., music) based on the music representation 718. The music generation system 700 can then execute the GAN-based modules in sequence to generate the audio data 720. In some embodiments, the user interface manager 702 enables the user to listen to the generated audio data 720, or intermediate audio data 722 generated as part of the music generation process. In some embodiments, the user interface manager 702 also, or alternatively, enables the user to view a representation of the generated music, intermediate audio representations 724 (e.g., spectrograms, etc.), etc.

As illustrated in FIG. 7, the music generation system 700 also includes a neural network manager 704. Neural network manager 704 may host a plurality of neural networks or other machine learning models, diffusion model 712. The neural network manager 704 may include an execution environment, libraries, and/or any other data needed to execute the machine learning models. In some embodiments, the neural network manager 704 may be associated with dedicated software and/or hardware resources to execute the machine learning models. Although depicted in FIG. 7 as being hosted by a single neural network manager 704, in various embodiments the neural networks may be hosted in multiple neural network managers and/or as part of different components. For example, each network can be hosted by their own neural network manager, or other host environment, in which the respective neural networks execute, or the networks may be spread across multiple neural network managers depending on, e.g., the resource requirements of each network, etc.

The HiFi vocoder 708 can receive the music representation 718 and generate a low-resolution audio waveform (e.g., intermediate audio data). The HiFi vocoder 708 can be implemented using a GAN architecture which may be trained to generate low resolution audio based on an input image or other pixel-based representation of music, as discussed above.

The bandwidth extension module 710 receives the low-resolution audio and upsamples the low-resolution audio into high-resolution audio. In some embodiments, the generated high-resolution audio is single channel (e.g., monophonic). Bandwidth extension module 106 can be implemented using the same GAN architecture as the HiFi vocoder 104 but trained to generate high-resolution audio based on input low-resolution audio.

The mono-to-stereo module 712 can receive the high-resolution audio, or a representation thereof, from the bandwidth extension module 710. Mono-to-stereo module 712 can also be implemented using the same GAN architecture as the other modules. For the mono-to-stereo module 712, the network is trained to generate stereophonic audio based on a representation of monophonic audio data. As discussed, in some embodiments, the mono-to-stereo module 712 can receive a representation of the high-resolution monophonic audio data and its corresponding generated audio data (e.g., waveform data). The mono-to-stereo module 712 can then predict the side channel audio data based on the representation of the high-resolution monophonic audio data. The resulting side channel audio data and high-resolution monophonic audio data can then be used to decode the high-resolution stereophonic audio data (e.g., left and right channels), as discussed above. The high-resolution stereo audio data is then output as generated audio data 720.

As discussed, the HiFi vocoder 708, bandwidth extension module 710, and mono-to-stereo module 712 share a unified generator and discriminator architecture. In some embodiments, the generator architecture may include a BigVGAN generator architecture. Alternatively, embodiments can also use the Aero generator architecture for bandwidth extension, but still use the same discriminator. Although specific architectures are noted herein, various generator architectures may be used, depending on implementation. These modules take Mel-spectrograms as input and output the corresponding raw waveform and internally use a specialized 1D convolutional architecture.

In some embodiments, this architecture may include a stack of anti-aliased multiperiodicity composition (AMP) blocks to generate the 1-D audio signals. These AMP blocks incorporate snake activation functions, which are specifically designed to adjust frequencies in a controllable manner and naturally represent raw waveforms through multi-periodic components. To mitigate aliasing artifacts that could arise from the snake activations, AMP also involves pre-upsampling along the time axis, followed by low-pass filtering, and concludes with downsampling to restore the signals to their original signal length.

Similarly, these modules may also use a unified discriminator architecture. In some embodiments, the unified discriminator includes a multi-period discriminator (MPD) and a multi-band multi-resolution complex spectrogram discriminator (MMSD). Each of these discriminators generally comprises several subdiscriminators with each functioning on various resolution windows of the waveform. The MPD, initially introduced, transforms the 1-D time-domain signal into 2-D representations of varying heights and widths. This approach captures multiple periodic structures separately through 2-D convolutions. The MMSD functions on various complex spectrograms with different STFT (Short-Time Fourier Transform) resolutions. This enhances high-frequency prediction and mitigates aliasing artifacts by not only incorporating phase information but also by splitting the STFT into sub-bands.

As discussed, these modules may be trained based on a weighted sum of the least-square adversarial loss, an L1 feature matching loss, and a multi-scale frequency domain L1 Mel-spectral reconstruction loss. In some embodiments, the reconstruction loss is calculated using various window lengths with 85% overlap and corresponding Mel-bins. This enhances training stability, fidelity, and convergence speed. Furthermore, employing the smallest hop size improves the modeling of very quick transients in the music domain. Depending on the module being trained, different reconstruction targets are used.

For vocoder training, Mel-spectrograms are used as input, and the corresponding waveform with the same bandwidth serves as the training target. For bandwidth extension training, low bandwidth Mel-spectrograms are used as the generator input for synthesizing the full bandwidth waveform. Experimentally, the generator was unable to resynthesize the full band waveform when directly using low bandwidth Mel-spectrograms as input. To address this issue, embodiments add a skip-connection including a sinc-interpolated ground truth low bandwidth waveform that is integrated into the output. The combined outputs then serve as the predicted full-band waveform and are trained alongside the ground truth full-band waveform. This approach not only facilitates successful reconstruction of the full band waveform but also helps in preserving the low frequency band components.

For M2S training, M/S (Mid/Side) encoding is employed. The Mel-spectrogram of the mid-channel M audio is used as input to predict the side channel S waveform, where M=(L+R)/2 and S=(L−R)/2, L is the left stereo channel, and R is the right stereo channel. Then for inference, embodiments use L=M+S/2 and R=M−S/2 to reconstruct the L and R channels from middle and side signals.

This allows for the preservation of the midchannel during inference, which is advantageous for further panning applications and allows us to objectively measure spatial performance on only the side-channel since we maintain the middle channel signal directly. This yields better and faster results when compared to state-of-the-art techniques and is differentiable which is useful for further downstream applications.

As illustrated in FIG. 7, the music generation system 700 also includes the storage manager 706. The storage manager 706 maintains data for the music generation system 700. The storage manager 706 can maintain data of any type, size, or kind as necessary to perform the functions of the music generation system 700. The storage manager 706, as shown in FIG. 7, includes music representation 718. The music representation 718 can include visual representations, audio representations, and/or other representations of music generated by the music generation system 700. For example, generated representation data 720 can include an audio representation, a pixel representation (such as a spectrogram output of the final generated output), a latent representation, etc.

As further illustrated in FIG. 7, the storage manager 706 also includes generated audio data 720. The generated audio data 720 can include a high-fidelity audio waveform corresponding to the music representation which has been generated by the music generation system as discussed above. The storage manager 706 may also include intermediate audio data 722 and intermediate audio representation(s) 724. As discussed, the music generation process can progressively generate audio data from low-resolution audio data to high-resolution monophonic audio data, to high-resolution stereophonic audio data. These intermediate audio waveforms can be stored, permanently or temporarily, by storage manager 706. Similarly, corresponding intermediate audio representation data 724 can also be stored by storage manager 706 for use in the music generation process, as discussed above.

Each of the components 702-710 of the music generation system 700 and their corresponding elements (as shown in FIG. 7) may be in communication with one another using any suitable communication technologies. It will be recognized that although components 702-710 and their corresponding elements are shown to be separate in FIG. 7, any of components 702-710 and their corresponding elements may be combined into fewer components, such as into a single facility or module, divided into more components, or configured into different components as may serve a particular embodiment.

The components 702-710 and their corresponding elements can comprise software, hardware, or both. For example, the components 702-710 and their corresponding elements can comprise one or more instructions stored on a computer-readable storage medium and executable by processors of one or more computing devices. When executed by the one or more processors, the computer-executable instructions of the music generation system 700 can cause a client device and/or a server device to perform the methods described herein. Alternatively, the components 702-710 and their corresponding elements can comprise hardware, such as a special purpose processing device to perform a certain function or group of functions. Additionally, the components 702-710 and their corresponding elements can comprise a combination of computer-executable instructions and hardware.

Furthermore, the components 702-710 of the music generation system 700 may, for example, be implemented as one or more stand-alone applications, as one or more modules of an application, as one or more plug-ins, as one or more library functions or functions that may be called by other applications, and/or as a cloud-computing model. Thus, the components 702-710 of the music generation system 700 may be implemented as a stand-alone application, such as a desktop or mobile application. Furthermore, the components 702-710 of the music generation system 700 may be implemented as one or more web-based applications hosted on a remote server. Alternatively, or additionally, the components of the music generation system 700 may be implemented in a suite of mobile device applications or “apps.”

As shown, the music generation system 700 can be implemented as a single system. In other embodiments, the music generation system 700 can be implemented in whole, or in part, across multiple systems. For example, one or more functions of the music generation system 700 can be performed by one or more servers, and one or more functions of the music generation system 700 can be performed by one or more client devices. The one or more servers and/or one or more client devices may generate, store, receive, and transmit any type of data used by the music generation system 700, as described herein.

In one implementation, the one or more client devices can include or implement at least a portion of the music generation system 700. In other implementations, the one or more servers can include or implement at least a portion of the music generation system 700. For instance, the music generation system 700 can include an application running on the one or more servers or a portion of the music generation system 700 can be downloaded from the one or more servers. Additionally or alternatively, the music generation system 700 can include a web hosting application that allows the client device(s) to interact with content hosted at the one or more server(s).

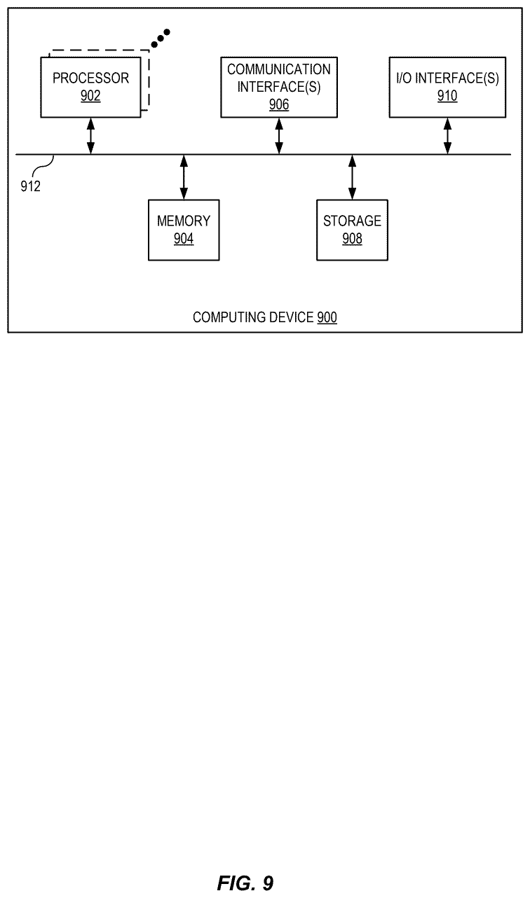

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 9. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 9.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 9.

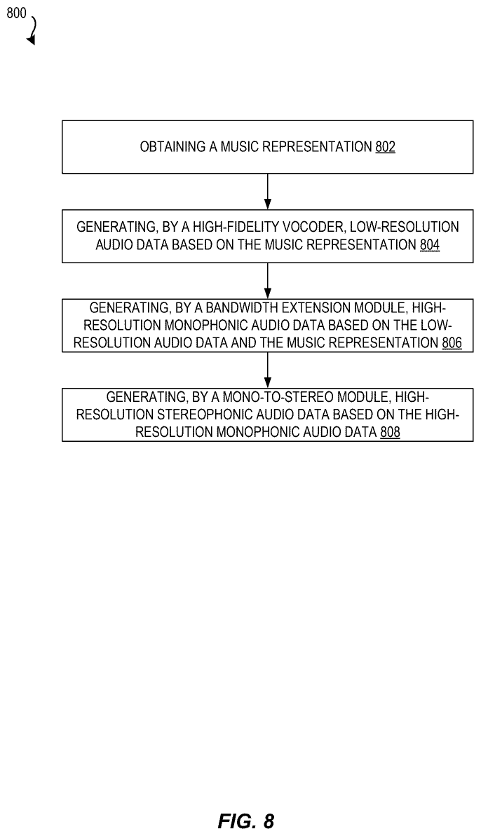

FIGS. 1-7, the corresponding text, and the examples, provide a number of different systems and devices that allow a user to generate music with inference time controls. In addition to the foregoing, embodiments can also be described in terms of flowcharts comprising acts and steps in a method for accomplishing a particular result. For example, FIG. 8 illustrates a flowchart of an exemplary method in accordance with one or more embodiments. The method described in relation to FIG. 8 may be performed with fewer or more steps/acts or the steps/acts may be performed in differing orders. Additionally, the steps/acts described herein may be repeated or performed in parallel with one another or in parallel with different instances of the same or similar steps/acts.

FIG. 8 illustrates a flowchart 800 of a series of acts in a method of music generation in accordance with one or more embodiments. In one or more embodiments, the method 800 is performed in a digital medium environment that includes the music generation system 700. The method 800 is intended to be illustrative of one or more methods in accordance with the present disclosure and is not intended to limit potential embodiments. Alternative embodiments can include additional, fewer, or different steps than those articulated in FIG. 8.

As illustrated in FIG. 8, the method 800 includes an act 802 of obtaining a music representation. As discussed, in some embodiments, the music representation can be obtained from a storage location, provided by a user, or otherwise sourced or generated. For example, in some embodiments, the music representation is a pixel-based representation. In some embodiments, the pixel-based representation is a Mel-spectrogram generated by a text-to-image diffusion model.

As illustrated in FIG. 8, the method 800 also includes an act 804 of generating, by a high-fidelity vocoder, low-resolution audio data based on the music representation. In some embodiments, the high-fidelity vocoder comprises a generative adversarial network trained to generate an audio waveform based on an input representation of music.

As illustrated in FIG. 8, the method 800 also includes an act 806 of generating, by a bandwidth extension module, high-resolution monophonic audio data based on the low-resolution audio data and the music representation. In some embodiments, the bandwidth extension module includes a generator model which is trained as part of a generative adversarial network by obtaining low-resolution training audio data, obtaining a music representation of the low-resolution training audio data, upsampling the low-resolution audio data using an interpolation block, generating upsampled intermediate audio data, and combining the upsampled intermediate audio data and the upsampled low-resolution audio data to generate predicted audio data. In some embodiments, the interpolation block is a sinc interpolation block added via a skip connection. In some embodiments, the generator model is further trained by evaluating the predicted audio data by a discriminator model and training the generator model and the discriminator model based on the evaluation of the predicted audio data and a weighted sum of loss functions.

As illustrated in FIG. 8, the method 800 also includes an act 808 of generating, by a mono-to-stereo module, high-resolution stereophonic audio data based on the high-resolution monophonic audio data. In some embodiments, the high-fidelity vocoder, bandwidth extension module, and mono-to-stereo module share a generative adversarial network architecture. In some embodiments, generating, by a mono-to-stereo module, high-resolution stereophonic audio data based on the high-resolution monophonic audio data, further includes generating, by a generator model of the mono-to-stereo module, side channel audio data based on the high-resolution monophonic audio data. The high-resolution monophonic audio data and the side channel audio data are combined to generate left channel audio data and right channel audio data. The high-resolution stereophonic audio data includes the left channel audio data and the right channel audio data.

In some embodiments, the method further includes receiving a request to modify a spatialization width of the high-resolution monophonic audio data and updating a control coefficient based on the request, wherein the control coefficient controls an energy ratio between a side channel and a mid-channel associated with the high-resolution monophonic audio data.

In some embodiments, a method of music generation includes receiving a request to generate music, obtaining a representation of the music, executing a cascade of a plurality of generative adversarial network (GAN) based models to generate and progressively increase fidelity of the music generated based on the representation of the music, and outputting generated high-resolution stereophonic music generated by the cascade of the plurality of GAN based models. In some embodiments, the cascade of the plurality of GAN based models includes a high-fidelity vocoder which generates low-resolution audio data based on the representation of the music, a bandwidth extension module which generates high-resolution monophonic audio data based on the low-resolution audio data and the representation of the music, and a mono-to-stereo module which generates high-resolution stereophonic audio data based at least on the high-resolution monophonic audio data.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 that may be configured to perform one or more of the processes described above. One will appreciate that one or more computing devices such as the computing device 900 may implement the music generation system. As shown by FIG. 9, the computing device can comprise a processor 902, memory 904, one or more communication interfaces 906, a storage device 908, and one or more I/O devices/interfaces 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 908 and decode and execute them. In various embodiments, the processor(s) 902 may include one or more central processing units (CPUs), graphics processing units (GPUs), field programmable gate arrays (FPGAs), systems on chip (SoC), or other processor(s) or combinations of processors.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 904 may be internal or distributed memory.

The computing device 900 can further include one or more communication interfaces 906. A communication interface 906 can include hardware, software, or both. The communication interface 906 can provide one or more interfaces for communication (such as, for example, packet-based communication) between the computing device and one or more other computing devices 900 or one or more networks. As an example and not by way of limitation, communication interface 906 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can comprise hardware, software, or both that couples components of computing device 900 to each other.

The computing device 900 includes a storage device 908 includes storage for storing data or instructions. As an example, and not by way of limitation, storage device 908 can comprise a non-transitory storage medium described above. The storage device 908 may include a hard disk drive (HDD), flash memory, a Universal Serial Bus (USB) drive or a combination these or other storage devices. The computing device 900 also includes one or more input or output (“I/O”) devices/interfaces 910, which are provided to allow a user to provide input to (such as user strokes), receive output from, and otherwise transfer data to and from the computing device 900. These I/O devices/interfaces 910 may include a mouse, keypad or a keyboard, a touch screen, camera, optical scanner, network interface, modem, other known I/O devices or a combination of such I/O devices/interfaces 910. The touch screen may be activated with a stylus or a finger.

The I/O devices/interfaces 910 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 910 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
obtaining a music representation;
generating, by a high-fidelity vocoder, low-resolution audio data based on the music representation;
generating, by a bandwidth extension module, high-resolution monophonic audio data based on the low-resolution audio data and the music representation; and
generating, by a mono-to-stereo module, high-resolution stereophonic audio data based on the high-resolution monophonic audio data.

2. The method of claim 1, wherein the high-fidelity vocoder, bandwidth extension module, and mono-to-stereo module share a generative adversarial network architecture.

3. The method of claim 1, wherein the high-fidelity vocoder comprises a generative adversarial network trained to generate an audio waveform based on an input representation of music.

4. The method of claim 1, wherein the bandwidth extension module includes a generator model which is trained as part of a generative adversarial network by:
obtaining low-resolution training audio data;
obtaining a music representation of the low-resolution training audio data;
upsampling the low-resolution audio data using an interpolation block;
generating upsampled intermediate audio data; and
combining the upsampled intermediate audio data and the upsampled low-resolution audio data to generate predicted audio data.

5. The method of claim 4, wherein the interpolation block is a sinc interpolation block added via a skip connection.

6. The method of claim 4, wherein the generator model is further trained by:
evaluating the predicted audio data by a discriminator model; and
training the generator model and the discriminator model based on the evaluation of the predicted audio data and a weighted sum of loss functions.

7. The method of claim 1, wherein generating, by a mono-to-stereo module, high-resolution stereophonic audio data based on the high-resolution monophonic audio data, further comprises:
generating, by a generator model of the mono-to-stereo module, side channel audio data based on the high-resolution monophonic audio data; and
combining the high-resolution monophonic audio data and the side channel audio data to generate left channel audio data and right channel audio data, wherein the high-resolution stereophonic audio data includes the left channel audio data and the right channel audio data.

8. The method of claim 1, wherein the music representation is a Mel-spectrogram generated by a text-to-image diffusion model.

9. The method of claim 1, further comprising:
receiving a request to modify a spatialization width of the high-resolution monophonic audio data; and
updating a control coefficient based on the request, wherein the control coefficient controls an energy ratio between a side channel and a mid-channel associated with the high-resolution monophonic audio data.

10. A non-transitory computer-readable medium storing executable instructions, which when executed by a processing device, cause the processing device to perform operations comprising:
obtaining a music representation;
generating, by a high-fidelity vocoder, low-resolution audio data based on the music representation;
generating, by a bandwidth extension module, high-resolution monophonic audio data based on the low-resolution audio data and the music representation; and
generating, by a mono-to-stereo module, high-resolution stereophonic audio data based on the high-resolution monophonic audio data.

11. The non-transitory computer-readable medium of claim 10, wherein the high-fidelity vocoder, bandwidth extension module, and mono-to-stereo module share a generative adversarial network architecture.

12. The non-transitory computer-readable medium of claim 10, wherein the high-fidelity vocoder comprises a generative adversarial network trained to generate an audio waveform based on an input representation of music.

13. The non-transitory computer-readable medium of claim 10, wherein the bandwidth extension module includes a generator model which is trained as part of a generative adversarial network by:
obtaining low-resolution training audio data;
obtaining a music representation of the low-resolution training audio data;
upsampling the low-resolution audio data using an interpolation block;
generating upsampled intermediate audio data; and
combining the upsampled intermediate audio data and the upsampled low-resolution audio data to generate predicted audio data.

14. The non-transitory computer-readable medium of claim 13, wherein the interpolation block is a sinc interpolation block added via a skip connection.

15. The non-transitory computer-readable medium of claim 13, wherein the generator model is further trained by:
evaluating the predicted audio data by a discriminator model; and
training the generator model and the discriminator model based on the evaluation of the predicted audio data and a weighted sum of loss functions.

16. The non-transitory computer-readable medium of claim 10, wherein the operation of generating, by a mono-to-stereo module, high-resolution stereophonic audio data based on the high-resolution monophonic audio data, further comprises:
generating, by a generator model of the mono-to-stereo module, side channel audio data based on the high-resolution monophonic audio data; and
combining the high-resolution monophonic audio data and the side channel audio data to generate left channel audio data and right channel audio data, wherein the high-resolution stereophonic audio data includes the left channel audio data and the right channel audio data.

17. The non-transitory computer-readable medium of claim 10, wherein the music representation is a pixel-based representation.

18. The non-transitory computer-readable medium of claim 17, wherein the pixel-based representation is a Mel-spectrogram generated by a text-to-image diffusion model.

19. A system comprising:
a memory component; and
a processing device coupled to the memory component, the processing device to perform operations comprising:
receiving a request to restore input music;
executing one or more of a plurality of generative adversarial network (GAN) based models to progressively increase fidelity of the input music; and
outputting restored music generated by the one or more of the plurality of GAN based models.

20. The system of claim 19, wherein the one or more of the plurality of GAN based models includes at least one of:
a bandwidth extension module which generates high-resolution monophonic audio data based on the input music; and
a mono-to-stereo module which generates high-resolution stereophonic audio data based at least on the input music.
